(19) United States
(12) Patent Application Publication
(10) Pub. No.: US 2009/0151762 A1
(43) Pub. Date: Jun. 18, 2009

(54) Stand device for a crutch and crutch comprising a stand device

(76) Inventors: Marga Schlosser, Amberg (DE); Hubert Scheiteuberger, Mallensdorf-Pfoffenberg (DE); Berthold Burgmeier, Thamassing (DE)

Correspondence Address: LERNER GREENBERG STEMER LLP, P O BOX 2480, HOLLYWOOD, FL, 33022-2480, US

(21) Appl. No.: 11/597,121

(22) PCT Filed: Mar. 19, 2005
(86) PCT No.: PCT/EP2005/002967

§ 371 Date: Apr. 8, 2008

(30) Foreign Application Priority Data
May 21, 2004 (DE) 20 2004 008 411.2

(51) Int. Cl. A61H 3/02

(52) U.S. Cl. 135/66

(57) ABSTRACT

The invention relates to a stand device for a crutch with a force transmission system comprising a ratchet mechanism and at least two supporting legs that can be folded out from a standby position into a standing position and vice versa. A gear that compensates for overlifting of the ratchet mechanism is allocated to the force transmission system.

The innovation concerns a stand device for a crutch and a crutch comprising a stand device, according to the preambles of claims 1 and 9, respectively.

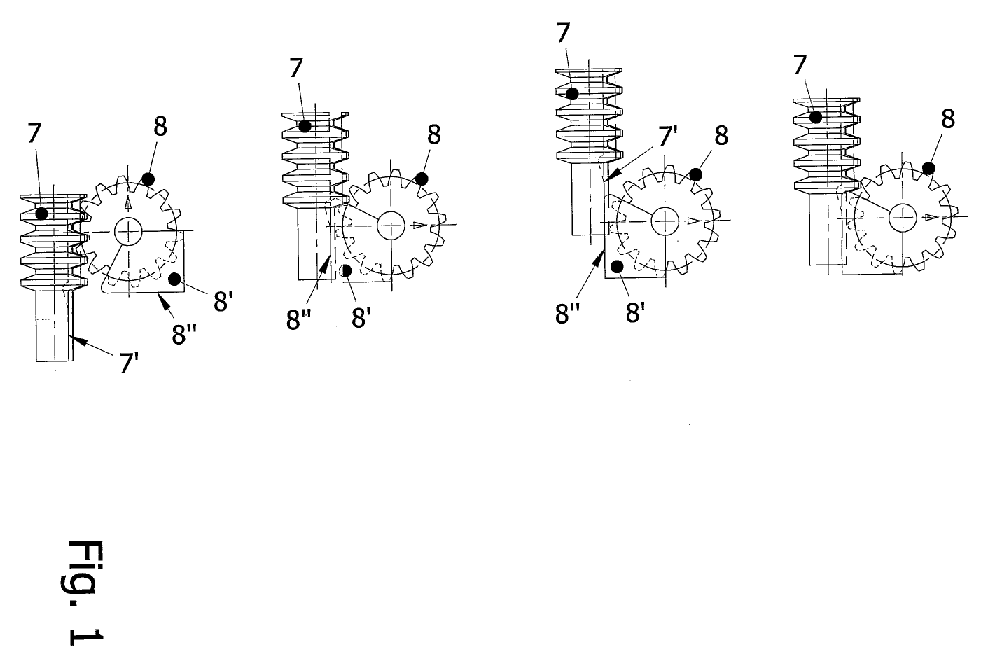

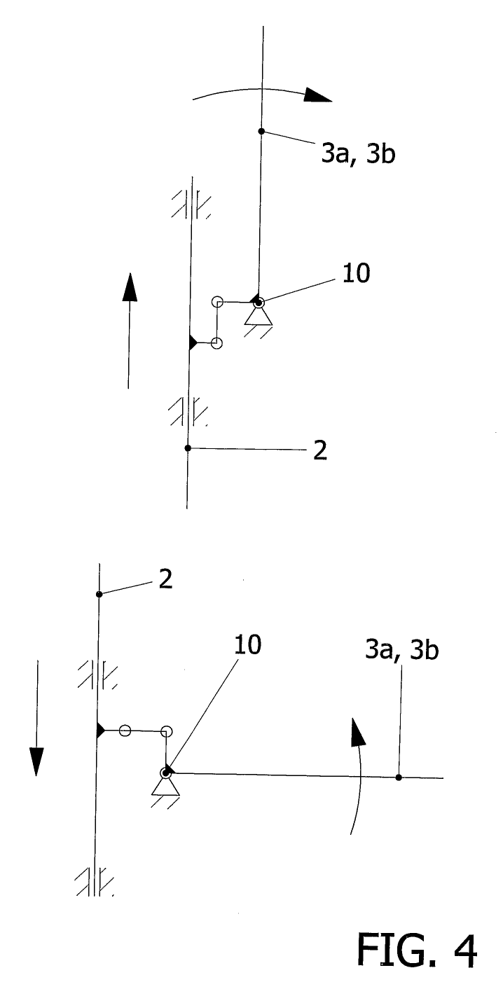

Stand devices for crutches, and crutches comprising such stand devices, are known from EP 0 958 803 A1 and EP 1 136 054 A1. The stand devices can be designed as structures that can be retrofitted onto a conventional crutch, or as integral component parts installed in the crutch. Optimum operation by one hand is afforded in both cases, this being permitted by a ratchet mechanism incorporated in a force transmission system. By virtue of this ratchet mechanism, the supporting legs of the stand device can be folded out and folded in simply by a pulling movement made from the handgrip of the crutch. Both positions of the supporting legs can be seen from FIG. 1 of the abovementioned European patent applications. The function of the aforementioned ratchet mechanism is illustrated in FIGS. 4 and 5 and explained in the associated description. The content of the two European patent applications mentioned is expressly incorporated into this application.

One flaw lies in a functionally related peculiarity of the ratchet mechanism which, when actuated, requires or executes an overlifting. This overlifting can be clearly observed in the actuation of a pen, with conventional press-button operation and in principle the same ratchet mechanism, when the writing nib, during actuation of the press-button, initially emerges from the body of the pen to a distance beyond the subsequent writing position, in order thereafter to slide back a distance into the body of the pen until the writing nib is arrested or locked in the writing position by the ratchet mechanism. Since, in the known stand device, the tooth segments mounted on the supporting legs are permanently in form-fit engagement with constant transmission ratio in a toothed rack connected directly to the ratchet mechanism (see FIG. 4 of the European patent applications), the supporting legs also execute the aforementioned overlifting movement of the ratchet mechanism when actuated, which for various reasons is regarded as a disadvantage.

Accordingly, the object of the innovation is to make available a stand device that is improved in this respect, and a crutch comprising a corresponding stand device.

This object is achieved by the characterizing features of claims 1 and 9, respectively.

Instead of the tooth segments that have hitherto been used and that are permanently engaged in a toothed rack, a gear construction is now provided which, seen in the direction of force flow, is arranged between the ratchet mechanism and the supporting legs and which compensates for overlifting of the ratchet mechanism. In this way, when the supporting legs are folded out from the standby position into the standing position, they do not pivot beyond this. Also, when the supporting legs are folded in, they no longer pivot initially beyond the standing position.

Advantageous gear constructions are a toothed step-by-step gear or a sliding bow transmission. Lever gears are also conceivable.

In the toothed step-by-step gear, the tooth segments disengage from the toothed rack when the supporting legs reach the standing position and, during the subsequent overlifting movement of the ratchet mechanism, are fixed or guided in the reached position without following the overlifting movement.

The sliding bow transmission, by contrast, comprises a specially shaped slide (guide) and a cam roller or sliding block that engages in the slide. In this embodiment, there are no tooth segments and no toothed rack. Each supporting leg can have a rotationally fixed slide, and the tie-rod of the force transmission system comprising the ratchet mechanism can have cam rollers or sliding blocks, or vice versa. The shape of the slide is adapted to the geometric conditions such that the overlifting of the ratchet mechanism is not converted into a pivoting movement of the supporting legs.

Other advantageous embodiments of the innovation are the subject matter of the remaining dependent claims.

Preferred illustrative embodiments are explained below with reference to the figures, in which:

FIG. 1 shows a toothed step-by-step gear in four different operating positions,

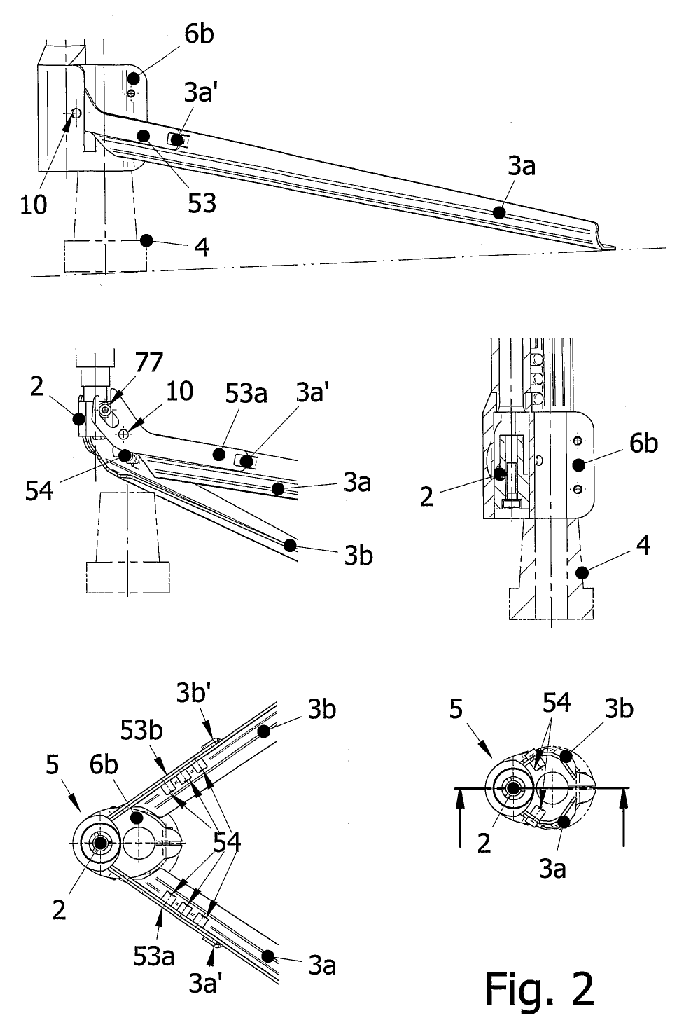

FIG. 2 shows several views of a sliding bow transmission according to a first embodiment,

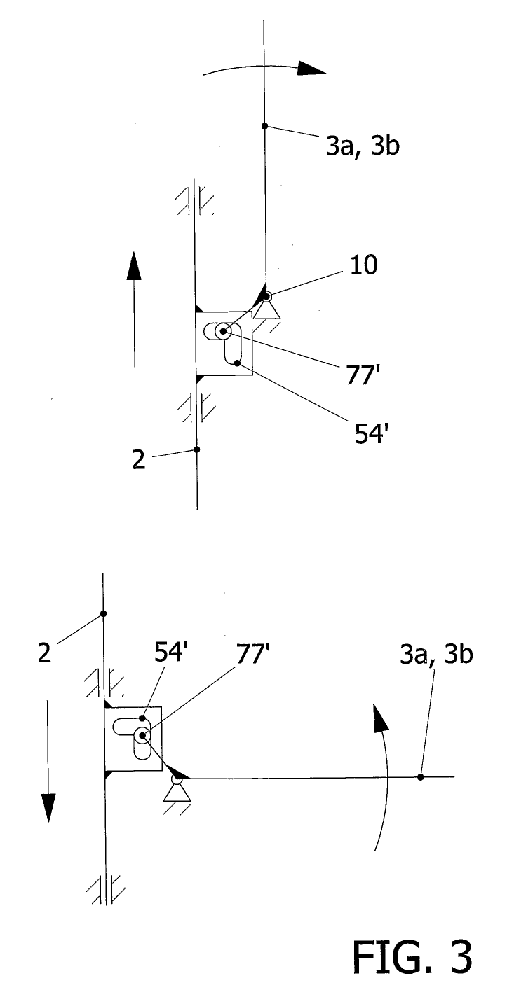

FIG. 3 shows a sliding bow transmission according to a second embodiment, and

FIG. 4 shows a lever gear.

The toothed step-by-step gear according to FIG. 1 differs from the one in FIG. 4 of the two European patent applications mentioned in the introductory part of the description in that the toothed rack 7 as a whole is shorter, such that the tooth segments 8 disengage from the toothed rack 7 when the standing position of the supporting legs is reached. To ensure that the tooth segments 8, and the supporting legs 3a, 3b connected in a rotationally fixed manner to each of these, remain fixed during the subsequent overlifting, a guide body 8′, arranged in a rotationally fixed manner on each segment 8, has a guide surface 8″ that slides on an extension stub 7″ formed integrally below the toothed rack. The extension stub has corresponding recesses for the guide surface. The movement during folding-out of the supporting legs into the standing position can be followed from left to right in the sequence of figures. Accordingly, the folding-in of the supporting legs takes place in the reverse sequence, i.e. from right to left.

FIG. 2 shows a sliding bow transmission in which there is no toothed rack secured at the lower end of the tie-rod 2 coming from the ratchet mechanism 5, and instead a cam roller 77 is in each case secured on two opposite sides. In the embodiment shown, the supporting legs are in two parts, namely composed of angle levers 53a, 53b that can be folded about the pivot bearing 10 present in the lower clamp 6b, and of the supporting legs 3a, 3b that are secured releasably on this angle lever via three spring-mounted pressure pieces 54. Laterally deflected tongues 3a′, 3b′ engaging over the angle levers are located on the supporting legs. By means of the tongues and the end of the supporting legs 3a, 3b that is inserted into a slit between an angle lever and the clamp 6b, these supporting legs 3a, 3b, in connection with the pressure pieces 54, are coupled to the angle levers and can be loaded by a force up to a predefined limit value. In the event of overloading, the pressure pieces release the connection, as a result of which the gear and the ratchet mechanism 5 are protected from damage.

At the area facing toward the tie-rod 2, a slide 54 that is open at one end is formed in the angle levers, which slide has a curved profile toward the pivot bearing 10, and into which slide one of the aforementioned cam rollers 77 engages with a form fit. The shape of the slide is such that the overlifting movement of the cam rollers 77 is not converted into a pivoting movement of the angle levers 53a and 53b, and instead these remain in the standing position reached.

The clamp 6b has a bore for receiving the lower end of the bar of a crutch when the stand device forms a structure that can be attached externally to a conventional crutch. The clamp can be omitted if the entire force transmission system, i.e. the tie-rod 2 and the ratchet mechanism 5, and if appropriate other structural parts, are accommodated and protected in the interior of the bar of the crutch and not visible from the outside.

FIG. 3 shows a schematic representation of a reversal of the embodiment shown in FIG. 2. In this embodiment, the slide 54′ is located on and connected in terms of movement to the tie-rod 2, whereas the members engaging in the slide, e.g. cam rollers 77′, are assigned to the supporting legs 3a, 3b. The slides in the embodiments in FIGS. 2 and 3 can be modified such that only a control surface at one end is provided and the cam roller is held permanently in contact with this control surface via a spring element.

FIG. 4 is a schematic representation of a lever gear construction in which the supporting legs 3a, 3b foldable about the pivot bearings 10 each have an actuating lever which is formed integrally on them at approximately right angles and which is connected to the tie-rod 2 by means of a connecting rod articulated at both ends. The geometric relationships are chosen such that the connecting rod and the actuating lever in the left-hand standby position are approximately at right angles to one another, while the connecting rod is substantially parallel to the tie-rod. In the right-hand standing position of the supporting legs, by contrast, the connecting rod is approximately at right angles to the tie-rod, such that the overlifting has practically no effect on the supporting legs.

1. A stand device for a crutch, with a force transmission system comprising a ratchet mechanism, and with at least two supporting legs that can be folded out from a standby position into a standing position and vice versa, characterized in that a gear that compensates for overlifting of the ratchet mechanism is allocated to the force transmission system.

2. The device as claimed in claim 1, characterized in that the gear is arranged, in the direction of force flow, between the ratchet mechanism and the supporting legs.

3. The device as claimed in claim 1 or 2, characterized in that the gear is a toothed-wheel step-by-step gear.

4. The device as claimed in claim 1 or 2, characterized in that the gear is a lever gear.

5. The device as claimed in claim 4, characterized in that the lever gear has a connecting rod which is articulated, at one end, on a tie-rod of the force transmission system and, at the other end, on a lever arm on the supporting leg.

6. The device as claimed in claim 1 or 2, characterized in that the gear is a sliding bow transmission.

7. The device as claimed in claim 6, characterized in that the sliding bow transmission is composed of at least one slide and of a cam roller or sliding block that engages with a form-fit in the slide, said slide being connected movably to a supporting leg, and the cam roller or sliding block being connected movably to the tie-rod of the force transmission system, or vice versa.

8. The device as claimed in claim 7, characterized in that the slide has a kinked, boomerang-like profile with two substantially straight branches which are oriented with respect to one another at an angle different than 180 degrees, preferably at an angle of approximately 135 degrees.

9. A crutch with a bar which comprises a handgrip and a foot and whose area near the foot includes supporting legs which can be folded out from a standby position into a standing position and vice versa and which, by way of a force transmission system comprising a ratchet mechanism, are connected to an actuating element allocated to the handgrip, characterized in that a gear that compensates for overlifting of the ratchet mechanism is allocated to the force transmission system of the stand device.

10. The crutch as claimed in claim 9, characterized in that the gear of the stand device is designed as claimed in at least one of preceding claims 1 through 8.

11. The crutch as claimed in claim 9 or 10, characterized in that the stand device is designed as a structure that can be attached externally to the crutch.

12. The crutch as claimed in claim 9 or 10, characterized in that at least part of the stand device is integrated in the bar of the crutch, in particular the force transmission system, the ratchet mechanism, and the gear that compensates for overlifting.
